(19) United States
(12) Patent Application Publication
(10) Pub. No.: US 2008/0291120 A1
(43) Pub. Date: Nov. 27, 2008

(54) HEAD-MOUNTED DISPLAY FOR ADJUSTING THE INTENSITY OF AMBIENT LIGHTS

(75) Inventors: Biing Seng Wu, Tainan County (TW); Yen Chen Chen, Tainan County (TW); Kun Tai Chen, Tainan County (TW); Kuo Yuin Li, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX DISPLAY, INC., Tainan County (TW)

(21) Appl. No.: 12/061,301

(22) Filed: Apr. 2, 2008

(30) Foreign Application Priority Data
May 22, 2007 (TW) 096118112

(51) Int. Cl. G02B 27/01; G02B 27/28

(52) U.S. Cl. 345/8; 359/246

(57) ABSTRACT

A head-mounted display includes a body including an optical visualizing device. The optical visualizing device includes a displaying unit, a housing, a polarizing unit and a front cover. The displaying unit is adapted to display an image. The housing is adapted to accommodate the displaying unit and having a front surface. The polarizing unit is disposed in front of the displaying unit accommodated in the housing for adjusting the intensity of ambient lights that enter the displaying unit. The front cover is adapted to cover the front surface of the housing. The polarizing unit is controlled by the viewer to switch between see-through and non-see-through mode.

### CROSS REFERENCE TO RELATED APPLICATION

This application claims the priority benefit of Taiwan Patent Application Serial Number 096118112, May 22, 2007, the full disclosure of which is incorporated herein by reference.

### BACKGROUND OF THE INVENTION

1. Field of the Invention

This invention relates to an optical visualizing apparatus, and more particularly to a head-mounted display.

2. Description of the Related Art

Head-mounted display (HMD) is an optical visualizing apparatus that utilizes displaying devices positioned in front of the user's eyes so as to display a virtual image. Such is a kind of apparatus broadly used for a frontier of technology of the virtual reality (VR). In some circumstance, people particularly need to acquire an enrichment of the real world by means of a complementary virtual image. This is called as “augmented reality”. One approach to achieving the augmented reality is to render a virtual image which is imposed on external scenery by a see-through type HMD. The simple approach is to utilize an optical see-through design to allow the ambient light to pass through a transflective screen. The complex approach is to utilize a visual signal see-through design to transform the ambient light into the visual signal, then to combine the visual signal of the ambient light with the virtual image, and finally to show the combined image.

The optical see-through type HMD is not ideal for use when it is necessary to protect the displayed information from being revealed. A non-see-through design, of course, is free from such a reveal problem of the displayed information but gives up those functions with respect to the augmented reality. For example, the uncomforted feeling due to the image that is viewed in the virtual environment in the non-see-through type HMD can be a problem, whereas it can be reduced in the see-through type HMD by which the augmented reality is achieved.

To solve the above-mentioned problem, U.S. Pat. No. 6,050,717 discloses that an HMD comprises a liquid crystal (LC) shutter, wherein the viewer can switch one of the see-through and non-see-through modes to the other one thereof when seeing a virtual image and real scenery simultaneously. By changing the optical transmittance of the LC shutter, the intensity of the ambient light can be adjusted.

However, the LC shutter is expensive so as to increase the manufacture cost. Obviously, it is not necessary to use the expensive LC shutters for merely switching between the see-through and non-see-through modes. Accordingly, there exists a need for an HMD having a cheaper and simpler switching element capable of replacing the LC shutter and solving the above-mentioned problems of the manufacture cost.

### SUMMARY OF THE INVENTION

It is an object of the present invention to provide an HMD including polarizers which can adjust the intensity of the ambient lights and cause the viewer to see the external scenery and the virtual image simultaneously.

For this purpose, the present invention provides an HMD with a body having an optical visualizing device, the optical visualizing device including a displaying unit for displaying a virtual image, a housing for accommodating the displaying unit, a polarizing unit disposed in front of the displaying unit accommodated in the housing for adjusting the intensity of the ambient lights that enter the displaying unit, and a front cover for covering the front surface of the housing.

The polarizing unit according to the present invention includes two stacked polarizers for each eye of the viewer, adjusting the intensity of ambient lights passing to each eye by changing polarizing directions of the polarizers.

Other objects, advantages, and novel features of the invention will become more apparent from the following detailed description when taken in conjunction with the accompanying drawings.

### BRIEF DESCRIPTION OF THE DRAWINGS

FIG. 1 shows a perspective schematic view of an HMD according to an embodiment of the present invention.

FIG. 2 is an exploded perspective schematic view of an optical visualizing device according to the embodiment of the present invention.

FIG. 3 shows a perspective schematic view of a polarizing unit according to the embodiment of the present invention.

### DETAILED DESCRIPTION OF THE PREFERRED EMBODIMENT

This invention will become more apparent from a study of the following detailed description of a head-mounted displays (HMD) 1 and an optical visualizing device 4 thereof provided by the present embodiment, with reference to accompanying diagrams.

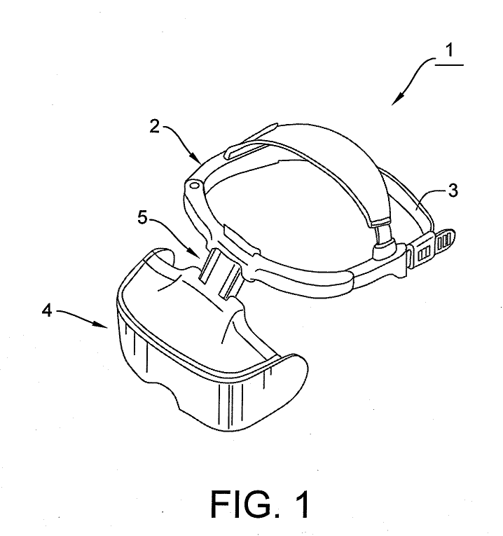

FIG. 1 is a diagram showing the HMD 1 according to an embodiment of the present invention. As shown in the figure, the HMD 1 includes a body 2, which may be connected to a remote controller by means of a wire manner or a wireless manner (not shown). The body 2 includes a head mount unit 3 for mounting the body 2 on the head of the viewer and an optical visualizing device 4 which is physically connected to the head mount unit 3 by a linking unit 5. The head mount unit 3 is designed to position the optical visualizing device 4 in front of the viewer's eyes.

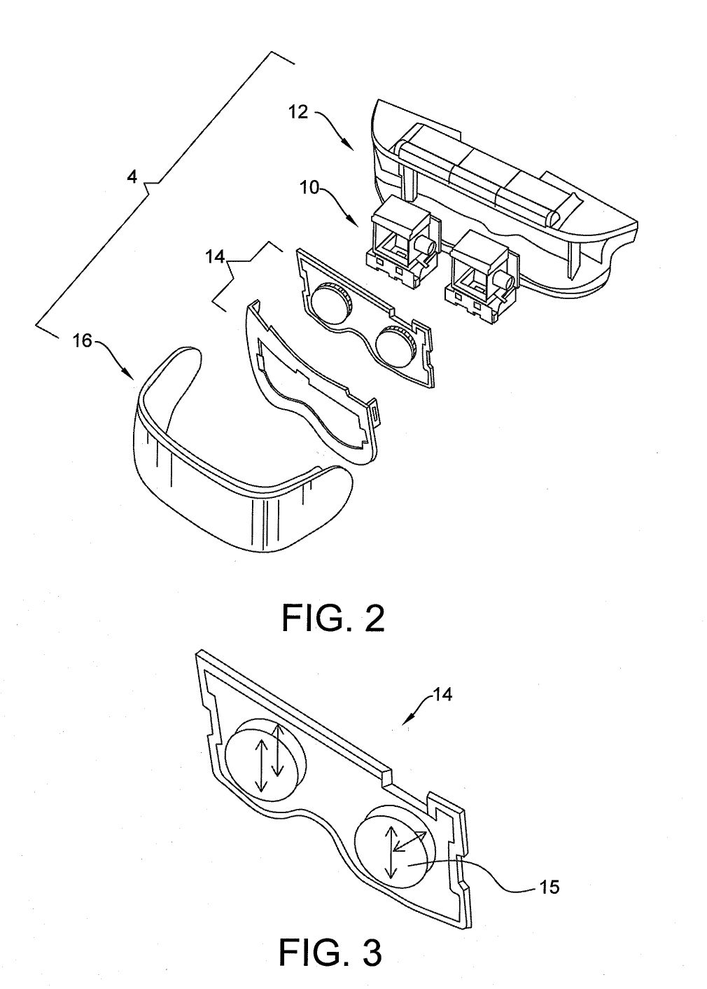

FIG. 2 is an exploded view of the optical visualizing device 4 according to the embodiment of the present invention. As shown in the figure, the optical visualizing device 4 includes a displaying unit 10 for displaying a virtual image, a housing 12 for accommodating the displaying unit 10, a polarizing unit 14 disposed in front of the displaying unit accommodated in the housing 12 for adjusting the intensity of the ambient lights entering the displaying unit 10, and a front cover 16 for covering the front surface of the housing 12. The housing 12 is physically connected to the linking unit 5 so as to be adjustable up and down.

FIG. 3 shows the polarizing unit 14 according to the embodiment of the present invention. As shown in FIG. 3, the polarizing unit 14 includes two stacked polarizers 15 for each eye of the viewer for adjusting the intensity of the ambient lights by changing polarizing directions of the polarizers 15, i.e. the polarizing unit 14 includes two stacked polarizers 15 corresponding to a left eye of the viewer and two stacked polarizers 15 corresponding to a right eye of the viewer. For each eye, one of the two stacked polarizers 15 is fixed while the other is rotatable and mechanically positioned. In another embodiment, both of the polarizers 15 for each eye can be rotatable.

The polarizers 15 are made of linearly polarizing material. When lights travel through a linearly polarizing material in a direction, a selected vibration plane of electric field is passed whereas electric field vectors vibrating in other directions are blocked. The intensity of ambient lights passing through the stacked polarizers 15 for each eye is determined by the polarizing directions of the polarizers 15. The intensity of ambient lights passing through a pair of stacked polarizers 15 (e.g. linear polarizers) can be quantitatively described by applying Malus' cosine-squared law, as a function of the angles between the transmission axes of the polarizers 15:

I=I₀·cos²θ.

That is, the stacked polarizers 15 are first and second linear polarizers, the polarized lights that have been transmitted through the first linear polarizer might be either transmitted through or absorbed by the second linear polarizer. The switch between transmission and absorbability depends on the angle between the transmission direction of the electric field vector of the second polarizer and that of the first polarizer. The see-through purpose can be fulfilled if the polarizing directions of the polarizers 15 are substantially parallel to each other so that the ambient lights pass though the polarizing unit 14 (for example, refer to the pair of polarizers 15 for the right eye in FIG. 3). The non-see-through purpose can be fulfilled if the polarizing directions of the polarizers 15 are substantially perpendicular to each other so that the ambient lights can be blocked by the polarizing unit 14 (for example, refer to the pair of polarizers 15 for the left eye in FIG. 3). The area of each polarizer 15 is slightly larger than the displaying area lights passing through the screen in the displaying unit 10 for each eye.

The HMD provided by the embodiments of present invention accomplishes the switch between see-through and non-see-through mode in application of augmented reality. The switching element adopted in the embodiments of this invention is a pair of polarizers, which are simpler and cheaper than those in prior art.

Although particular embodiments of this invention have been described for illustration, one skilled in the art will appreciate that various modifications and enhancements may be made without departing from the spirit and scope of the invention. For example, the second polarizer may be chosen to be a circular polarizer since the circular polarizer can block polarized lights equally well as the linear polarizer. The presently disclosed embodiments are therefore to be considered in all respects as illustrative and not restrictive, and the scope of the invention should be defined by the appended claims, not limited to the foregoing descriptions.

What is claimed is:

1. A head-mounted display comprising:
a body comprising an optical visualizing device, the optical visualizing device comprising:
a displaying unit adapted to display an image;
a housing adapted to accommodate the displaying unit and having a front surface;
a polarizing unit disposed in front of the displaying unit accommodated in the housing for adjusting the intensity of ambient lights that enter the displaying unit; and
a front cover adapted to cover the front surface of the housing.

2. The head-mounted display of claim 1, wherein the polarizing unit includes two stacked polarizers corresponding to a left eye of a viewer and two stacked polarizers corresponding to a right eye of the viewer for adjusting the intensity of the ambient lights by changing polarizing directions of the polarizers.

3. The head-mounted display of claim 1, wherein one of the two stacked polarizers is fixed.

4. The head-mounted display of claim 1, wherein both of the two stacked polarizers are rotatable.

5. The head-mounted display of claim 1, wherein the polarizers are linear polarizers.

6. The head-mounted display of claim 1, wherein the polarizers are circular polarizers.

7. An optical visualizing device comprising:
a displaying unit adapted to display an image; and
a polarizing unit disposed in front of the displaying unit for adjusting the intensity of ambient lights that enter the displaying unit.

8. The optical visualizing device of claim 7, further comprising:
a housing adapted to accommodate the displaying unit and having a front surface; and
a front cover adapted to cover the front surface of the housing,

9. The optical visualizing device of claim 8, wherein the polarizing unit includes two stacked polarizers corresponding to a left eye of a viewer and two stacked polarizers corresponding to a right eye of the viewer for adjusting the intensity of the ambient lights by changing polarizing directions of the polarizers.

10. The optical visualizing device of claim 8, wherein one of the two stacked polarizers is fixed.

11. The optical visualizing device of claim 8, wherein both of the two stacked polarizers are rotatable.

12. The optical visualizing device of claim 8, wherein the polarizers are linear polarizers.

13. The optical visualizing device of claim 8, wherein the polarizers are circular polarizers.
